(19) United States
(12) Patent Application Publication
(10) Pub. No.: US 2025/0374202 A1
(43) Pub. Date: Dec. 4, 2025

(54) METHOD AND DEVICE FOR CONSTANT ENVELOPE MULTIPLEXING IN WIRELESS COMMUNICATION SYSTEM

(71) Applicant: ELECTRONICS AND TELECOMMUNICATIONS RESEARCH INSTITUTE, Daejeon (KR)

(72) Inventor: Hyoung Soo LIM, Daejeon (KR)

(73) Assignee: ELECTRONICS AND TELECOMMUNICATIONS RESEARCH INSTITUTE, Daejeon (KR)

(21) Appl. No.: 18/875,501

(22) PCT Filed: Sep. 19, 2022
(86) PCT No.: PCT/KR2022/013984

§ 371 Date: Dec. 16, 2024

(30) Foreign Application Priority Data
Sep. 15, 2022 (KR) 10-2022-0116059

(51) Int. Cl. H04W 52/22; H04L 27/34

(52) U.S. Cl. CPC H04W 52/22; H04L 27/34

(57) ABSTRACT

A method by which a first device generates a multiplexing signal in a communication system, according to an embodiment, comprises the steps of: identifying first to third transmission powers, which are the respective transmission powers of first to third signals to be multiplexed and transmitted; generating an intermodulation component of the first to third signals; multiplying the first to third signals and the intermodulation component on the basis of the first to third transmission powers; and generating a multiplexing signal having a constant envelope by quadrature-phase-combining, with a linear combination result of the multiplied first and second signals, a linear combination result of the multiplied third signal and the multiplied intermodulation component, wherein the third transmission power can be greater than or equal to the second transmission power, and the second transmission power can be greater than or equal to the first transmission power.

### TECHNICAL FIELD

The present invention relates to a constant envelope multiplexing (CEM) technology in a radio communication system, and more particularly, to a constant envelope multiplexing technology for multiplexing a plurality of binary phase signals into a radio signal having a constant envelope.

### BACKGROUND ART

The satellite navigation system may provide navigation information to a user using a plurality of satellites in orbit of the Earth. The satellite navigation system may transmit a plurality of satellite navigation signals simultaneously at the same frequency. Here, the satellite navigation signals transmitted by the satellite navigation system can be spread with different spreading codes, and the signals having the same phase of in-phase (I) or quadrature-phase (Q) can be modulated into different chip pulse waveforms. The satellite navigation signals may be amplified by a high-power amplifier of a satellite navigation system or a satellite navigation signal generation and transmission system and then transmitted to a user receiver on the ground.

In order to reduce the complexity of generating and receiving satellite navigation signals, most chip pulses have a bi-phase waveform with one baseband absolute value (in other words, the same baseband absolute value). Here, due to the nature of the operating environment of the satellite navigation payload including the satellite navigation signal generation and transmission system, there may be many restrictions on available power and physical configuration (weight, volume, etc.) of the system. In order to enhance the efficiency of the high-power amplifier for amplifying the satellite navigation signal and to improve the quality of service (QoS) for users under such restrictions, the satellite navigation signals can be designed to have a constant envelope. This may mean that sample values of the multiplexer output signals for a plurality of signals using the same frequency have a constant magnitude. In the case where the number of signals to be multiplexed is three or more, the satellite navigation signals may not have a constant envelope through simple linear combining. In this case, in order to make the satellite navigation signals have a constant envelope, an intermodulation component may be added between signals to be multiplexed during modulation and multiplexing. Such an intermodulation component can be regarded as random noise in terms of receiving a satellite navigation signal. In other words, the power of the intermodulation component among the total transmission power of the satellite navigation payload transmitting the satellite navigation signals can be regarded as an inevitable efficiency loss of the multiplexer for the maximum efficiency of the high-power amplifier. Accordingly, there is a need for a constant envelope multiplexing method for maximizing efficiency within the range satisfying the design requirements of the satellite navigation payload or the satellite navigation signal.

The description provided in this background art section is made to help understand the background of the invention and may include matters other than the prior art already known to those skilled in the art.

### DISCLOSURE

### Technical Problem

It is an object of the present invention to meet the above requirement by providing a constant envelope multiplexing method and apparatus for multiplexing a plurality of binary phase signals modulated with a bi-phase chip pulse into a radio signal having a constant envelope in a radio communication system.

### Technical Solution

A multiplexed signal generation method of a first device in a communication system, according to a first exemplary embodiment of the present disclosure for achieving the above-described objective, may comprise: identifying a first to a third transmission power of a first to a third signal to be multiplexed to be transmitted; generating an intermodulation component of the first to third signals; multiplying the first to third signals and the intermodulation component based on the first to third transmission powers; and generating a multiplexed signal having a constant envelope by performing quadrature phase combination on a linear combination result of the multiplied third signal and the multiplied intermodulation component and a linear combination result of the multiplied first and second signals, wherein the third transmission power is greater than the second transmission power, and the second transmission power is greater than the first transmission power.

The generating the intermodulation component may comprise generating the intermodulation component through multiplication operation on the first to third signals.

The multiplying may comprise multiplying the first to third signals based on a first to a third coefficient determined based on root values of the first to third transmission powers.

The multiplying may comprise multiplying the intermodulation component based on a fourth coefficient determined based on a first to a third coefficient determined based on root values of the first to third transmission powers.

The generating the multiplexed signal may comprise: generating a first combined signal through a sum operation on the multiplied first signal and the multiplied second signal; generating a second combined signal through a difference operation on the multiplied third signal and the multiplied intermodulation component; and generating the multiplexed signal by quadrature-phase-combining the first and second combined signals.

The first signal may be represented by s₁, the second signal may be represented by s₂, the third signal may be represented by s₃, the first transmission power may be represented by P₁, the second transmission power may be represented by P₂, the transmission power may be represented by P₃, and the multiplexed signal may be represented s_{MUX}, s_{MUX}=\sqrt{P₁}s₁+\sqrt{P₂}s₂+j(P₃\sqrt{s₃}−P₁P₂/P₃s₁s₂s₃).

The first to third signals may be bi-phase unit-power signals.

A first device of a communication system, according to a second exemplary embodiment of the present disclosure for achieving the above-described objective, may comprise: a processor configured to control the first device to identify a first to a third transmission power of a first to a third signal to be multiplexed to be transmitted, generate an intermodulation component of the first to third signals, multiply the first to third signals and the intermodulation component based on the first to third transmission powers, and generate a multiplexed signal having a constant envelope by performing quadrature phase combination on a linear combination result of the multiplied third signal and the multiplied intermodulation component and a linear combination result of the multiplied first and second signals, wherein the third transmission power is greater than the second transit power, and the second transmission power is greater than the first transmission power.

The processor may be further configured to control the first device to generate the intermodulation component through multiplication operation on the first to third signals.

The processor may be further configured to control the first device to multiply the first to third signals based on a first to a third coefficient determined based on root values of the first to third transmission powers.

The processor may be further configured to control the first device to multiply the intermodulation component based on a fourth coefficient determined based on a first to a third coefficient determined based on root values of the first to third transmission powers.

The processor may be further configured to control the first device to generate a first combined signal through a sum operation on the multiplied first signal and the multiplied second signal, generate a second combined signal through a difference operation on the multiplied third signal and the multiplied intermodulation component, and generate the multiplexed signal by quadrature-phase-combining the first and second combined signals.

The first signal may be represented by s₁, the second signal may be represented by s₂, the third signal may be represented by s₃, the first transmission power may be represented by P₁, the second transmission power may be represented by P₂, the transmission power may be represented by P₃, and the multiplexed signal may be represented s_{MUX}, s_{MUX}=\sqrt{P₁}s₁+\sqrt{P₂}s₂+j(P₃\sqrt{s₃}−P₁P₂/P₃s₁s₂s₃).

### Advantageous Effects

A constant envelope multiplexing method and apparatus for a radio communication system according to an embodiment makes it possible for a communication node intending to transmit a plurality of transmission signals in a constant envelope multiplexed manner to multiply the transmission signals and intermodulation components of the transmission signals based on the transmission power of the respective transmission signals and generate a constant envelope multiplexed signal based on the linear combination and the quadrature-phase combination for each multiplication result. Through this, it is possible to improve the efficiency of the constant envelope multiplexing operation.

### DESCRIPTION OF DRAWINGS

FIG. 1 is a conceptual diagram illustrating a communication system according to an embodiment.

FIG. 2 is a block diagram illustrating a communication node constituting a communication system according to an embodiment.

FIG. 3 is a block diagram illustrating a constant envelope multiplexing apparatus of a communication system according to an embodiment.

FIG. 4 is a conceptual diagram illustrating a first circuit constituting a constant envelope multiplexing device in a communication system according to an embodiment.

FIG. 5 is a conceptual diagram for explaining an embodiment of a constant envelope multiplexing method in a communication system.

FIG. 6 is a flowchart illustrating an embodiment of a method of constant envelope multiplexing in a communication system.

FIGS. 7A to 7X are exemplary diagrams illustrating embodiments of constellation diagrams for a constant envelope multiplexed signal in a communication system.

### BEST MODE OF THE INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/of” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

In the following, a communication system to which exemplary embodiments according to the present disclosure are applied will be described. The communication system to which the exemplary embodiments according to the present disclosure are applied is not limited to the contents described below, and the exemplary embodiments according to the present disclosure can be applied to various communication systems. Here, the communication system may be referred to as a ‘communication network’.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

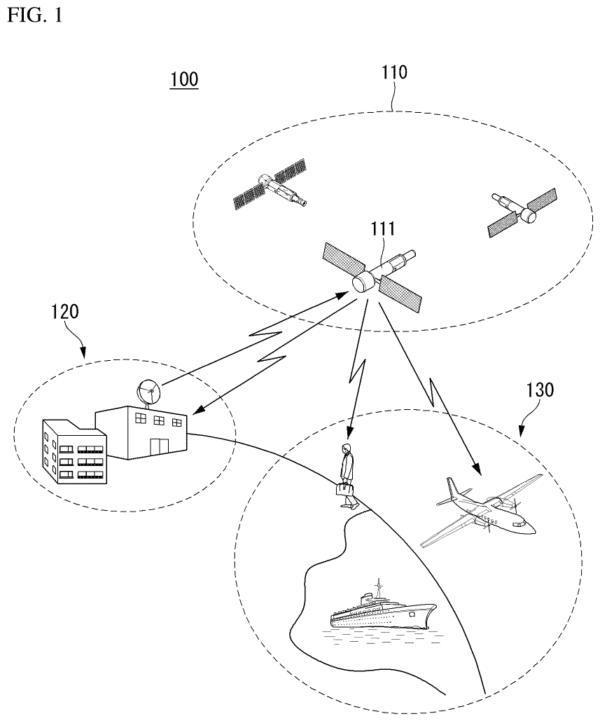

FIG. 1 is a conceptual diagram illustrating a communication system according to an embodiment.

With reference to FIG. 1, the communication system 100 may correspond to a satellite navigation system. The satellite navigation system 100 can provide users with navigation information such as three-dimensional position information and time synchronization information through distance measurement using satellite position information and radio waves received from a satellite group composed of a plurality of satellites in the earth's orbit. The satellite navigation system 100 may be referred to as a global navigation satellite system (GNSS).

The navigation satellites constituting the satellite navigation system 100 can transmit several satellite navigation signals on the same carrier to provide the users constituting the user segment 130 with positioning, navigation, and timing synchronization services for various purposes. The navigation satellite may be referred to as a satellite navigation payload 111.

The satellite navigation system may include a space segment 110, a control segment 120, and a user segment 130. The space unit 110 may include a satellite group consisting of a plurality of satellites, and a satellite navigation payload 111 included in one or more satellites. The control segment 120 may include a signal monitoring station and a master control station. The user segment 130 may include user equipment such as personal satellite communication equipment, aircraft, and ships. The master control station of the control segment 120 may be connected to the satellite navigation payload 111 through a data uplink channel via a ground antenna and may interoperate with the signal monitoring station.

The satellite navigation system 100 (or the satellite navigation payload 111 constituting the satellite navigation system 100) may transmit satellite navigation signals using frequency bands such as L1, L2, L5, L6, LEX, E1, E2, E5a, E5b, E6, B1, B1-2, B2, B3, and S. The satellite navigation system may include global positioning system (GPS), global navigation satellite system (GLONASS), Galileo, BeiDou navigation system (BDS), Quasi-Zenith satellite system (QZSS), navigation with Indian constellation (NavIC), and a next-generation satellite navigation system having a similar configuration such as a Korea positioning system (KPS).

The satellite navigation system 100 may generate a multiplexed signal by multiplexing a plurality of satellite navigation signals via a multiplexing device mounted on the satellite navigation payload 111. The satellite navigation system 100 may provide a satellite navigation service by transmitting the signal multiplexed via the multiplexing device to one or more users.

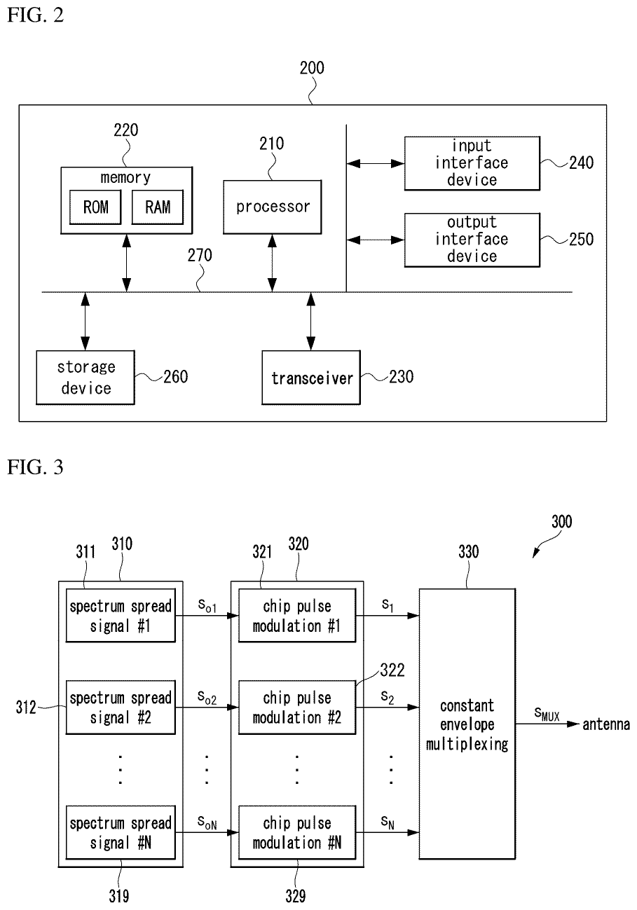

Each of the entities constituting the satellite navigation system 100 may be configured in an identical or similar manner to the communication node 200 to be described with reference to FIG. 2 below. The multiplexing device mounted on the satellite navigation payload 111 may be configured in an identical or similar manner to the constant envelope multiplexing device 300 to be described with reference to FIG. 3 below.

FIG. 2 is a block diagram illustrating a communication node constituting a communication system according to an embodiment.

With reference to FIG. 2, the communication node 200 may include at least one processor 210, a memory 220, and a transceiver 230 connected to a network to perform communication. In addition, the communication node 200 may further include an input interface device 240, an output interface device 250, and a storage device 260. Each of the components included in the communication node 200 may be connected via a bus 270 to communicate with each other.

The processor 210 may execute program instruction stored in at least one of the memory 220 and the storage unit 260. The processor 210 may refer to a central processing unit (CPU), a graphics processing unit (GPU), or a dedicated processor on which the methods according to embodiments of the present invention are performed. The memory 220 and the storage device 260 may each be configured as at least one of a volatile storage medium and a non-volatile storage medium. For example, the memory 220 may be configured as at least one of a read only memory (ROM) and a random access memory (RAM).

FIG. 3 is a block diagram illustrating a constant envelope multiplexing apparatus of a communication system according to an embodiment.

With reference to FIG. 3, the first communication node may include a constant envelope multiplexing device 300. The first communication node may be configured in an identical or similar manner to the satellite navigation payload 111 for transmitting the plurality of satellite navigation signals described with reference to FIG. 1. The first communication node may be configured in an identical or similar manner to the communication node 200 described with reference to FIG. 2.

The first communication node may generate a multiplexed output signal by multiplexing a plurality of signals to be transmitted via the constant envelope multiplexing apparatus 300. The constant envelope multiplexing apparatus 300 may include a signal generator 310, a modulator 320, and a multiplexer 330.

The signal generator 310 may generate N signals (N is a natural number greater than 1). For example, the signal generator 310 may include signal generator #1 311, signal generator #2 312, . . . , signal generator #N 319. The signal generator #1 to #N 311 to 319 may generate signals spread with different spreading codes. For example, the signal generator #1 311 may generate signal #1 (sₒ₁), the signal generator #2 312 may generate signal #2 (sₒ₂), and the signal generator #N 319 may generate signal #N (s_{oN}). In the case where the first communication node is a satellite navigation payload, signals #1 to #N (sₒ₁ to S_{oN}) generated by the signal generator 310 may correspond to satellite navigation signals including satellite navigation information. The signal generator 310 may use a direct sequence (DS) method, a frequency hopping (FH) method, a time hopping (TH) method, a chirp method, or a hybrid method obtained by altering and combining basic systems of two or more thereof. The signal generator 310 may output the generated signals #1 to #N (soi to S_{oN}) to the modulator 320.

The modulator 320 may modulate signals #1 to #N (sₒ₁ to s_{oN}) input from the signal generator 310 into different chip pulse waveforms. The modulator 320 may include modulator #1 321, modulator #2 322, . . . , and modulator #N 329. Signals #1 to #N (sₒ₁ to S_{oN}) output from the signal generator 310 may be input to modulators #1 to #N 321 to 329 included in the modulator 320, respectively. Modulators #1 to #N 321 to 329 may modulate the signals with the same phase that are acquired according to the amplitudes and phases of in-phase components and quadrature-phase components of the input signals #1 to #N (sₒ₁ to s_{oN}) into different chip pulse waveforms. Modulator #1 321 may output modulated signal #1 (s₁), modulator #2 322 may output modulated signal #2 (s₂), and modulator #N 329 may out modulated signal #N (s_{N}). Modulated signals #1 to #N (s₁ to s_{N}) may be bi-phase unit-power signals. Modulated signals #1 to #N (s₁ to s_{N}) output from the modulators #1 to #N 321 to 329 of the modulator 320 may be input to the multiplexer 330.

The multiplexer 330 may multiplex the modulated signals #1 to #N (s₁ to S_{N}) input from the modulator 320 to generate a multiplexed output signal. The multiplexer 330 may generate an output signal having a constant envelope (hereinafter referred to as ‘constant envelope’). The output signal output from the multiplexer 330 may be referred to as a ‘constant envelope multiplexed output signal’ or a ‘constant envelope multiplexed signal’ s_{MUX}(t).

In the case where the number of modulated signals #1 to #N (s₁ to S_{N}) to be multiplexed is three or more (i.e., when N is greater than 2), the output signal may not have a constant envelope simply by linearly combining the modulated signals #1 to #N (s₁ to S_{N}). The multiplexer 330 may perform a multiplexing operation with the inclusion of an intermodulation component between modulated signals #1 to #N (s₁ to S_{N}) in order to generate an output signal having a constant envelope. That is, the constant envelope multiplex signal s_{MUX}(t) may include components corresponding to modulated signals #1 to #N (s₁ to S_{N}) and an intermodulation component.

The first communication node may amplify the constant envelope multiplexed signal s_{MUX}(t) output from the constant envelope multiplexer via an amplifier and transmit the amplified constant envelope multiplexed signal S_{MUX}(t) via the antenna. The second communication node of the communication system may receive the constant envelope multiplexed signal s_{MUX}(t) transmitted from the first communication node. The power efficiency of the multiplexer 330 performing constant envelope multiplexing may be referred to as ‘constant envelope multiplexing (CEM) power efficiency’ or ‘CEM efficiency’.

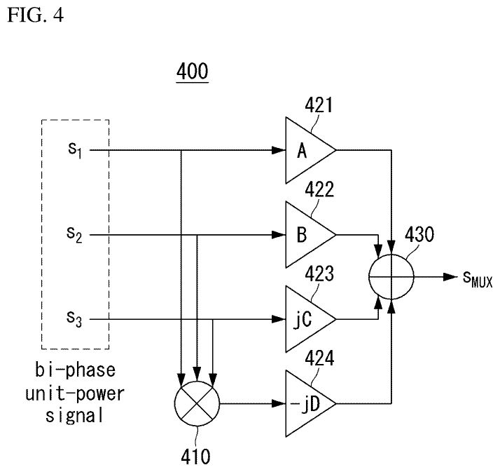

From the viewpoint of the second communication node receiving the constant envelope multiplexed signal s_{MUX}(t), the intermodulation component included in the constant envelope multiplexed signal s_{MUX}(t) may be regarded as random noise. In the first communication node (or the second communication node), the power of the intermodulation component among the total transmission power (or receive power) of the constant envelope multiplexed signal s_{MUX}(t) may be regarded as an inevitable loss in CEM efficiency of the multiplexer 330 for the maximum efficiency of the amplifier. A constant envelope multiplexing scheme for maximizing the CEM efficiency of the multiplexer 330 may be required. For example, the multiplexer 330 may be configured in an identical or similar manner to the first circuit to be described with reference to FIG. 4.

FIG. 4 is a conceptual diagram illustrating a first circuit constituting a constant envelope multiplexing device in a communication system according to an embodiment.

With reference to FIG. 4, in an embodiment of a communication system, the constant envelope multiplexing apparatus may perform a multiplexing operation on a plurality of multiplexing target signals. Here, the constant envelope multiplexing apparatus may be identical or similar to the constant envelope multiplexing apparatus 300 described with reference to FIG. 3 or the multiplexer 330 included in the constant envelope multiplexing apparatus 300. The constant envelope multiplexing apparatus may generate a constant envelope multiplexed signal by multiplexing N multiplexing target signals (N is a natural number greater than 1).

The constant envelope multiplexing apparatus may input N multiplexing target signals to the first circuit 400 constituting the constant envelope multiplexing apparatus. The first circuit 400 may correspond to the multiplexer 330 described with reference to FIG. 3. For example, the first circuit 400 may be identical or similar to the multiplexer 330 described with reference to FIG. 3. Alternatively, the first circuit 400 may be included in the multiplexer 330 described with reference to FIG. 3. The first circuit 400 may output a constant envelope multiplexed signal. FIG. 4 illustrates an embodiment of the first circuit constituting the constant envelope multiplexing apparatus with an exemplary case in which the constant envelope multiplexing device generates a constant envelope multiplexed signal s_{MUX}(t) by inputting three multiplexing target signals s₁(t), s₂(t), and s₃(t) to the first circuit. However, this is only an example for convenience of description, and the embodiment of the first circuit constituting the constant envelope multiplexing device is not limited thereto.

The constant envelope multiplexing apparatus may input the multiplexing target signals s₁(t), s₂(t), and s₃(t) to the first circuit 400. The multiplexing target signals s₁(t), s₂(t), and s₃(t) may correspond to binary-phase unit-power signals. The multiplexing target signals s₁(t), s₂(t), and s₃(t) may be expressed as s₁, s₂, and s₃ by omitting the time variable t.

Here, the multiplexing target signals s₁(t), s₂(t), and s₃(t) may be transmitted with the same or different transmission powers, respectively. The multiplexing target signals s₁(t), s₂(t), and s₃(t) may be viewed as being sorted in ascending order based on the transmission power for transmission. For example, when the transmission powers of the multiplexing target signals s₁(t), s₂(t), and s₃(t) are P₁, P₂, and P₃, respectively, P₁, P₂, and P₃ may have a relationship as in Equation 1

$$0 < {P}_{1} \leq {P}_{2} \leq {P}_{3} \qquad Equation 1$$

Meanwhile, the first circuit 400 may generate an intermodulation component s₁(t)s₂(t)s₃(t) for the multiplexing target signals s₁(t), s₂(t), and s₃(t). Assuming that the power of the intermodulation component s₁(t)s₂(t)s₃(t) is P_{IM} and the power of the constant envelope multiplexed signal s_{MUX}(t) is P_{MUX}, P₁, P₂, P₃, P_{IM}, and P_{MUX} may have relationships as in Equation 2

$${P}_{1} + {P}_{2} + {P}_{3} + {P}_{IM} = {P}_{MUX} \qquad Equation 2$$

$${P}_{1} + {P}_{2} + {P}_{3} = {P}_{MUX} - {P}_{IM} \leq {P}_{MUX}$$

The efficiency (i.e., CEM efficiency) of the constant envelope multiplexing operation in the first circuit 400 may be calculated as the sum of powers for each of the multiplexing target signals compared to the P_{MUX} corresponding to the total transmission power. For example, the CEM efficiency η of the first circuit 400 may be calculated as in Equation 3.

$$η = \frac{{P}_{1} + {P}_{2} + {P}_{3}}{{P}_{MUX}} = 1 - \frac{{P}_{IM}}{{P}_{MUX}} \qquad Equation 3$$

In an embodiment of the communication system, in the case where the multiplexing target signals s₁(t), s₂(t), and s₃(t) are simply linearly combined for transmission, the CEM efficiency of the first circuit 400 may become 0.75 (i.e., 75%) or less. The first circuit 400 may be configured to maximize CEM efficiency.

In the first circuit 400, the multiplexing target signals s₁(t), s₂(t), and s₃(t) may be input to the multiplication operator 410. The multiplication operator 410 may perform a multiplication operation on the multiplexing target signals s₁(t), s₂(t), and s₃(t). The multiplication operator 410 may output an intermodulation component s₁(t)s₂(t)s₃(t).

Among the multiplexing target signals, s₁(t) may be input to the first multiplier 421, s₂(t) may be input to the second multiplier 422, and s₃(t) may be input to the third multiplier 423. The intermodulation component s₁(t)s₂(t)s₃(t) output from the multiplication operator 410 may be input to the fourth multiplier 424. The first and multipliers 421 and 422 may perform a real multiplier operation, and the third and fourth multipliers 423 and 424 may perform an imaginary multiplier operation. The first to fourth multipliers 421 to 424 may output the multiplied signals to the combiner 430. The combiner 430 may linearly combine the signals input from the first to fourth multipliers 421 to 424 to output a constant envelope multiplexed signal s_{MUX}(t). In other words, the constant envelope multiplexed signal s_{MUX}(t) is the quadrature phase combination of the linear combination result of multiplied s₁(t) and multiplied s₂(t) and the linear combination result of multiplied s₃(t) and multiplied s₁(t)s₂(t)s₃(t).

In detail, the first and second multipliers 421 and 422 may output As₁(t) and Bs₂(t) by multiplying s₁(t) and s₂(t) by a real number A and a real number B, respectively. The third multiplier 423 may multiply s₃(t) by the imaginary number j and the real number C to output jCs₃(t). The fourth multiplier 424 may output −jDs4(t) by multiplying s₁(t)s₂(t)s₃(t) by the imaginary number j and the real number−D. Real numbers A, B, and C may be determined based on the transmission powers P₁, P₂, and P₃ of s₁(t), s₂(t), and s₃(t), respectively. For example, real numbers A, B, and C may be determined as in Equation 4.

$$A = \sqrt{{P}_{1}} \qquad Equation 4$$

$$B = \sqrt{{P}_{2}}$$

$$C = \sqrt{{P}_{3}}$$

Meanwhile, real number D may be determined based on real numbers A, B and C. For example, the real number D may be determined as in Equation 5.

$$D = \frac{AB}{C} \qquad Equation 5$$

The constant envelope multiplexed signal s_{MUX}(t) output from the combiner 430 may be equal or similar to Equation 6.

$$\begin{matrix}{s}_{MUX} ( t ) = {As}_{1} ( t ) + {Bs}_{2} ( t ) + j ( {Cs}_{3} ( t ) - {Ds}_{1} ( t ) {s}_{2} ( t ) {s}_{3} ( t ) ) \\ = \begin{matrix}\sqrt{{P}_{1}} {s}_{1} ( t ) + \sqrt{{P}_{2}} {s}_{2} ( t ) + \\ j ( \sqrt{{P}_{3}} {s}_{3} ( t ) - \sqrt{\frac{{P}_{1} {P}_{2}}{{P}_{3}}} {s}_{1} ( t ) {s}_{2} ( t ) {s}_{3} ( t ) )\end{matrix}\end{matrix} \qquad Equation 6$$

Equation 6 may be expressed as Equation 7 by omitting the time variable t.

$$\begin{matrix}{s}_{MUX} = {As}_{1} + B {s}_{2} + j ( {Cs}_{3} - D {s}_{1} {s}_{2} {s}_{3} ) \\ = \sqrt{{P}_{1}} {s}_{1} + \sqrt{{P}_{2}} {s}_{2} + j ( \sqrt{{P}_{3}} {s}_{3} - \sqrt{\frac{{P}_{1} {P}_{2}}{{P}_{3}}} {s}_{1} {s}_{2} {s}_{3} )\end{matrix} \qquad Equation 7$$

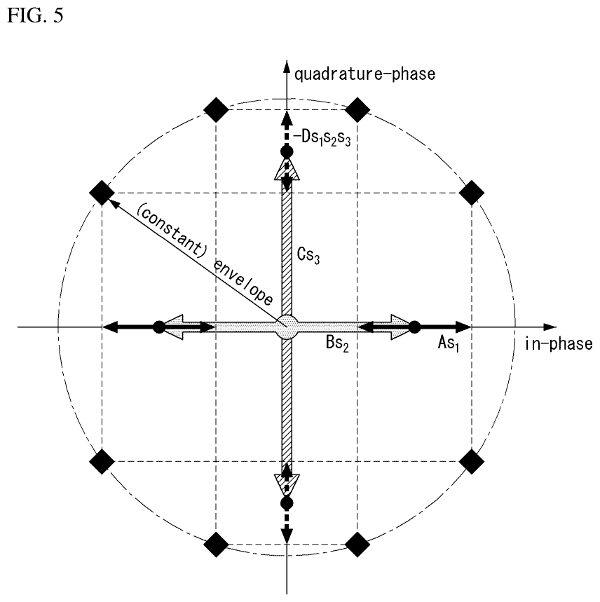

FIG. 5 is a conceptual diagram for explaining an embodiment of a constant envelope multiplexing method in a communication system.

With reference to FIG. 5, in an embodiment of a communication system, the constant envelope multiplexing apparatus may perform a multiplexing operation on a plurality of multiplexing target signals. Here, the constant envelope multiplexing device may be identical or similar to the constant envelope multiplexing device described with reference to FIG. 4.

The constant envelope multiplexing apparatus may generate a constant envelope multiplexing signal s_{MUX} through a constant envelope multiplexing operation on the multiplexing target signals s₁, s₂, and s₃. Here, the constant envelope multiplex signal s_{MUX} may include components corresponding to S₁, S₂, and S₃, and a component corresponding to s₁s₂s₃ multiplied by s₁, s₂, and s₃ (i.e., a intermodulation component). The constant envelope multiplex signal S_{MUX} may be viewed as a quadrature combination of the linear combination result of the multiplied s₁ and the multiplied s₂ and the linear combination result of the multiplied s₃ and the multiplied s₁s₂s₃.

In detail, As₁ multiplied by s1 and Bs₂ multiplied by s₂ may be linearly combined on the in-phase (I) axis. Meanwhile, Cs₃ multiplied by s₃ and −Ds₁s₂s₃ multiplied by s₁s₂s₃ may be linearly combined on the quadrature-phase (Q) axis. As₁+Bs₂, which is a result of linear combination on the I-axis, and Cs₃-Ds₁s₂s₃, which is a result of linear combination on the Q-axis, are quadrature-combined to generate a constant envelope multiplexed signal s_{MUX}=As₁+Bs₂+j(Cs₃−Ds₁s₂s₃).

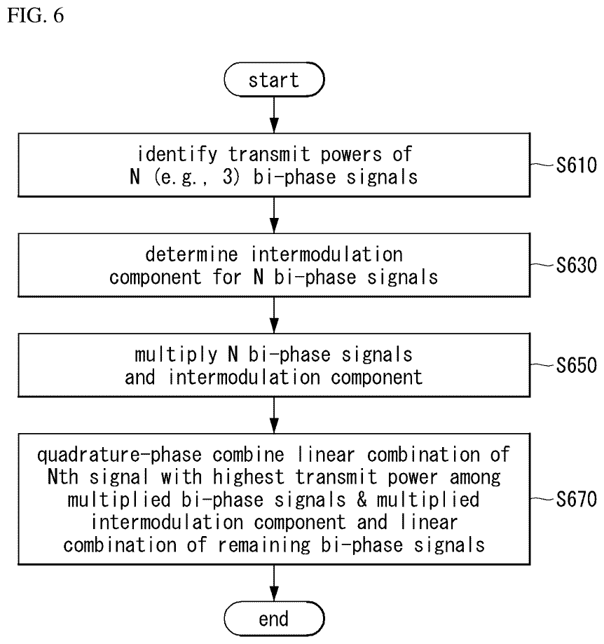

FIG. 6 is a flowchart illustrating an embodiment of a method of constant envelope multiplexing in a communication system.

With reference to FIG. 6, in an embodiment of a communication system, a first communication node may perform a constant envelope multiplexing operation on a plurality of multiplexing target signals. Here, the first communication node may be identical or similar to the first communication node described with reference to FIG. 3. The first communication node may perform the constant envelope multiplexing operation via a first device that is identical or similar to the constant envelope multiplexing device described with reference to FIG. 3 or 4. In the description, made hereinbelow with reference to FIG. 6, of an embodiment of the constant envelope multiplexing method in a communication system, content overlapping with those described with reference to FIGS. 1 to 5 may be omitted.

In an embodiment of the communication system, the first communication node may identify, at step S610, the strength of transmission power for transmitting each of N signals (N is a natural number greater than 1) to be multiplexed and transmitted. The N signals to be multiplexed and transmitted by the first communication node may be binary phase signals. In an embodiment of the communication system, N may be 3. Alternatively, in another embodiment of the communication system, in the case where N is greater than 2, the first communication node may select three signals among the N signals and identify the power to transmit each of the selected three signals. The first communication node may identify the transmission power values P₁, P₂, and P₃ of the first signal s₁, the second signal s₂, and the third signal s₃ to be multiplexed and transmitted. Among the three signals to be transmitted by the first communication node, a signal having the smallest transmission power may be regarded as the first signal s₁, a signal having the largest transmission power as the third signal s₃, and the remaining signal as the second signal s₂. The first to third signals s₁, s₂, and s₃ may be viewed as sorted in ascending order based on the values of transmission powers P₁, P₂, and P₃ to be transmitted. That is, it may be 0<P₁≤P₂≤P₃.

The first communication node may generate an intermodulation component for the first to third signals s₁, s₂, and s₃ at step S630. The intermodulation component may be generated by multiplying at least a part among the first to third signals s₁, s₂, and s₃. The intermodulation component may be determined as s₁s₂s₃.

The first communication node may multiply, at step S650, the first to third signals s₁, s₂, and s₃ and the intermodulation component s₁s₂s₃ generated at step S630.

The first communication node may multiply the coefficients A, B, C and D (or −D) determined in an identical or similar manner to Equations 4 and 5 to the first to third signals s1, s2, s3 and the intermodulation component s₁s₂s₃.

The first communication node may perform, at step S670, quadrature phase combination (i.e., As₁+Bs₂+j(Cs₃−Ds₁s₂s₃)) on the third signal Cs₃ with the largest transmission power among the multiplied first to third signals As₁, Bs₂, and Cs₃, the linear combination result (Cs₃-Ds₁s₂s₃) of multiplied intermodulation component (Ds₁s₂s₃ or -Ds₁s₂s₃), and the linear combination result (i.e., As₁+Bs₂) of the multiplied first and second signals As1 and Bs2. Through the quadrature combining operation at step S670, a constant envelope multiplex signal S_{MUX} may be generated.

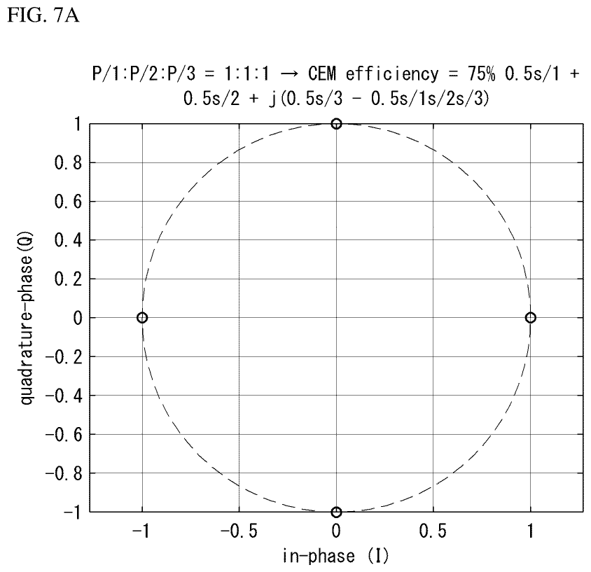

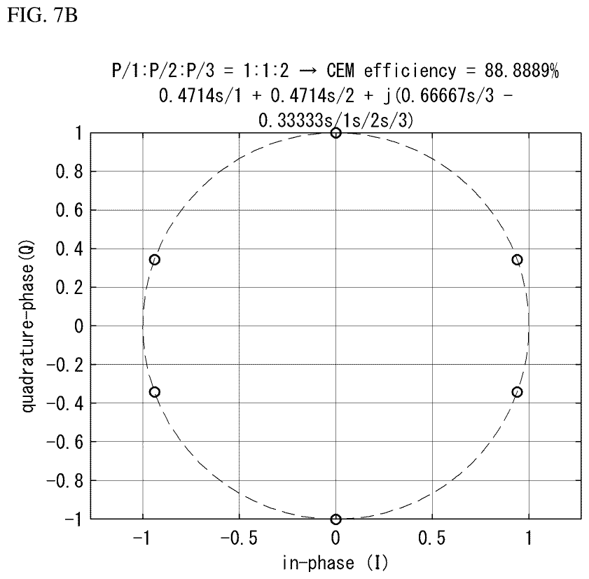

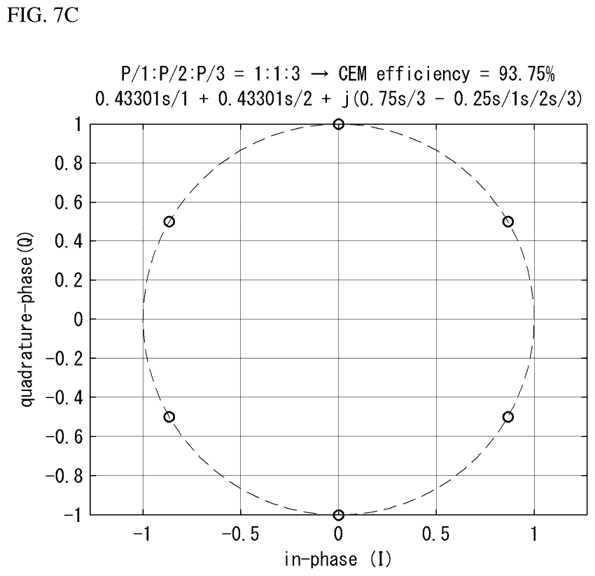

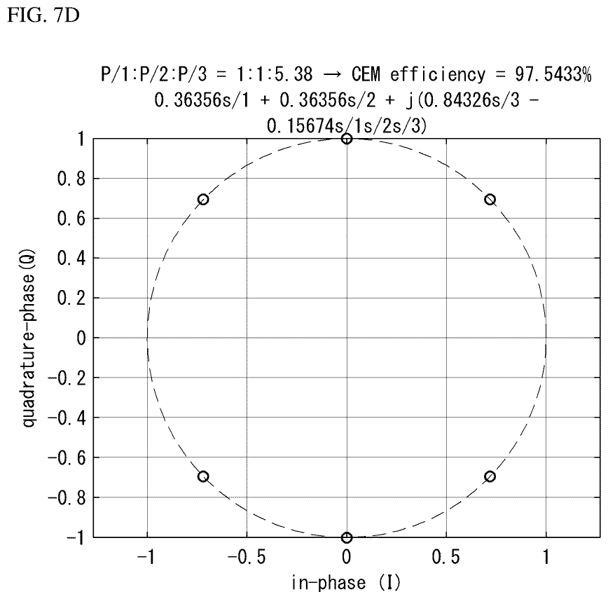

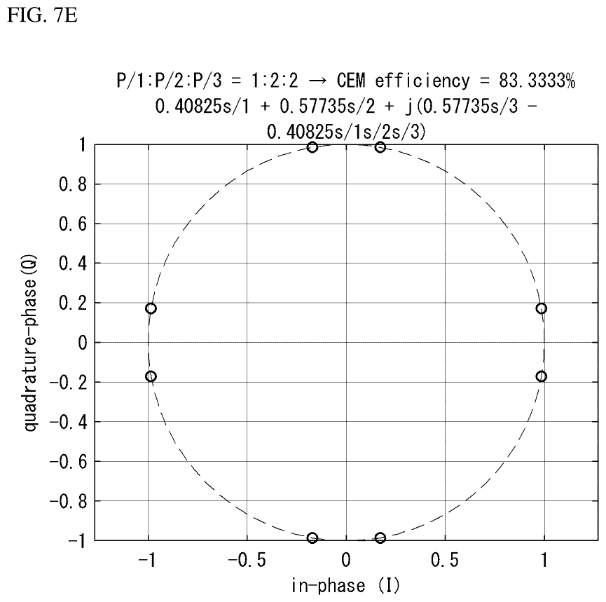

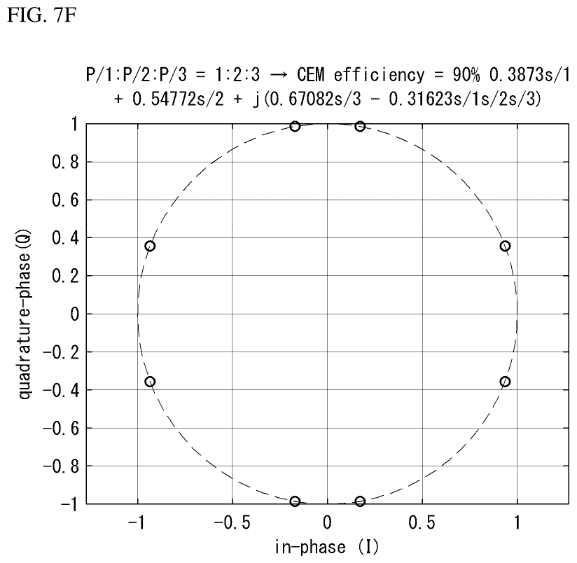

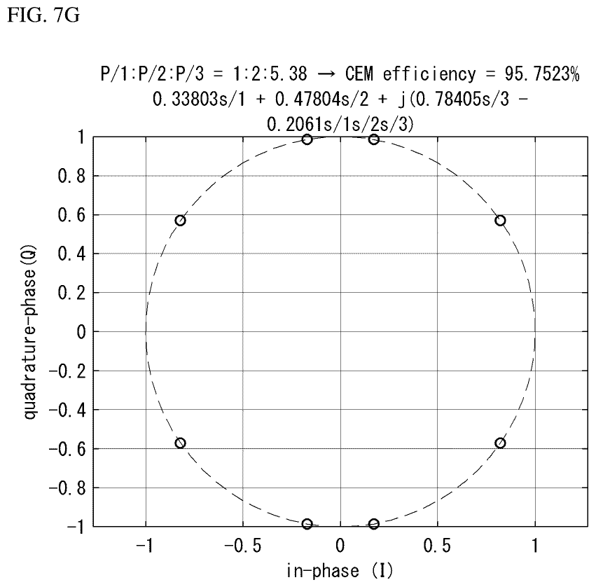

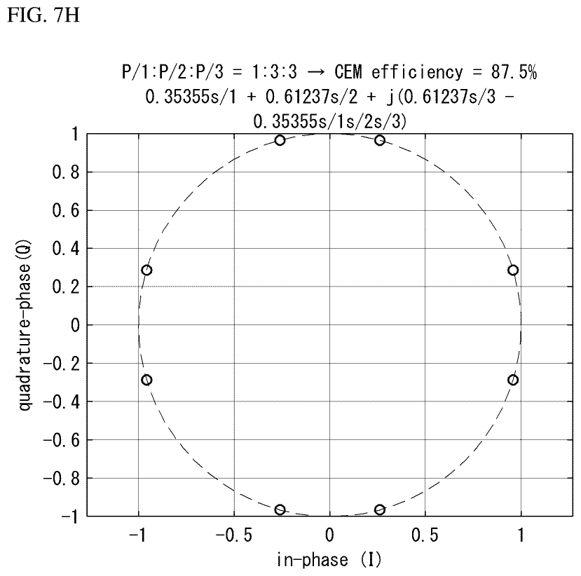

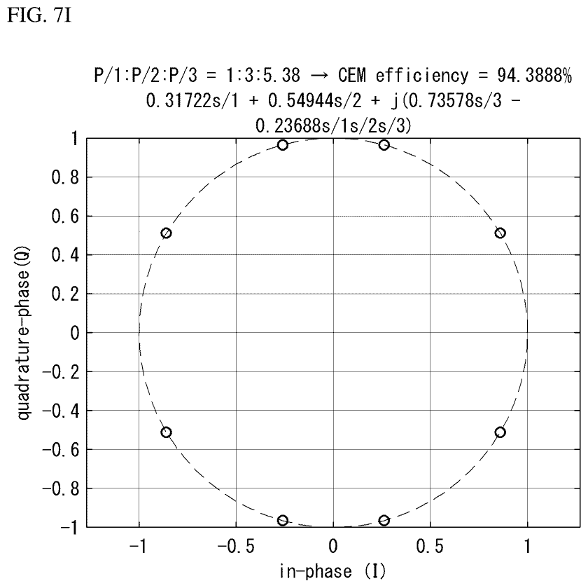

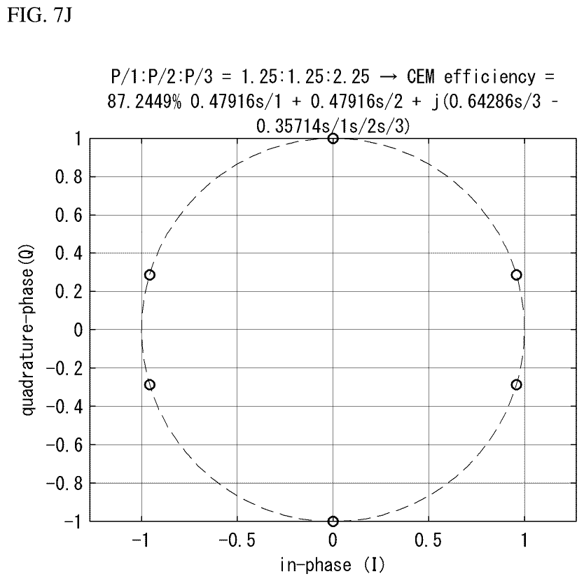

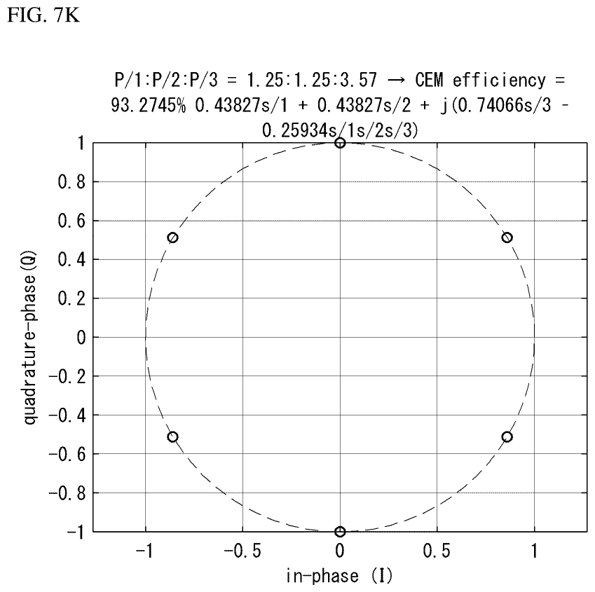

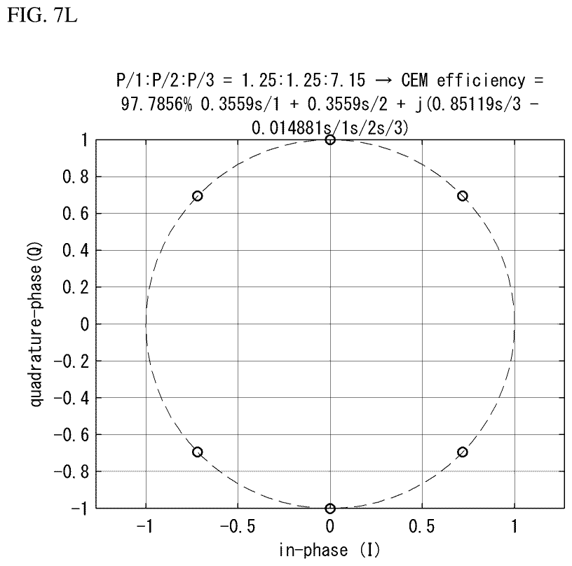

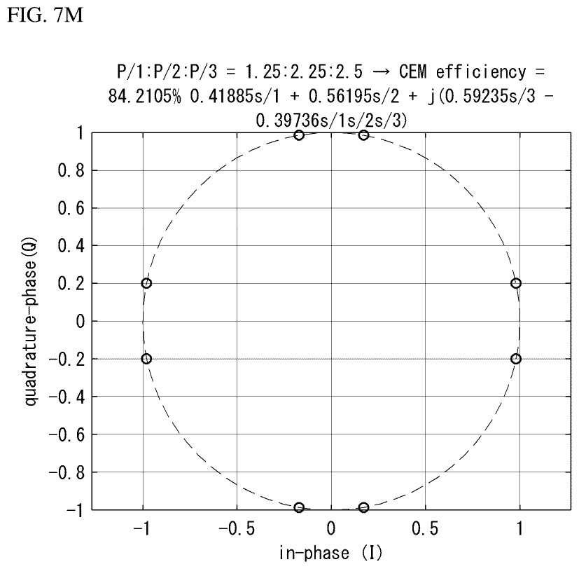

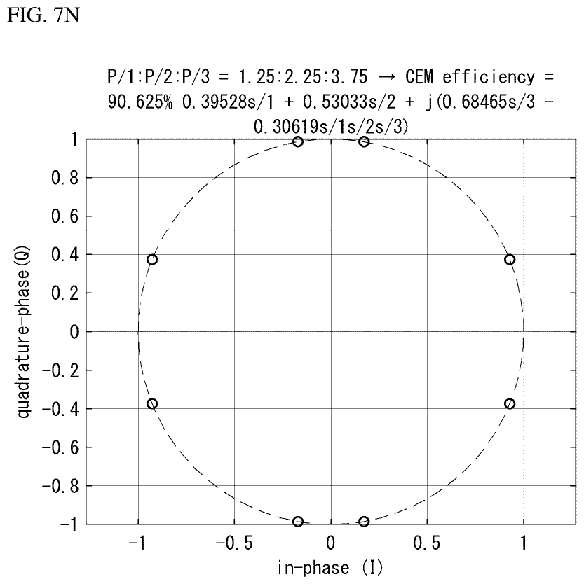

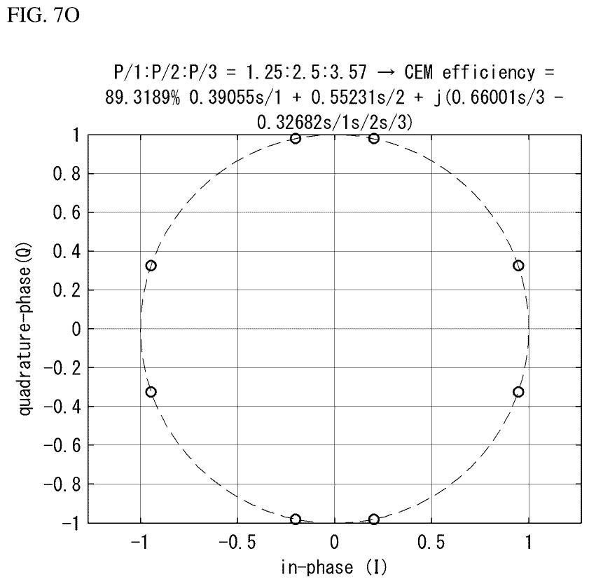

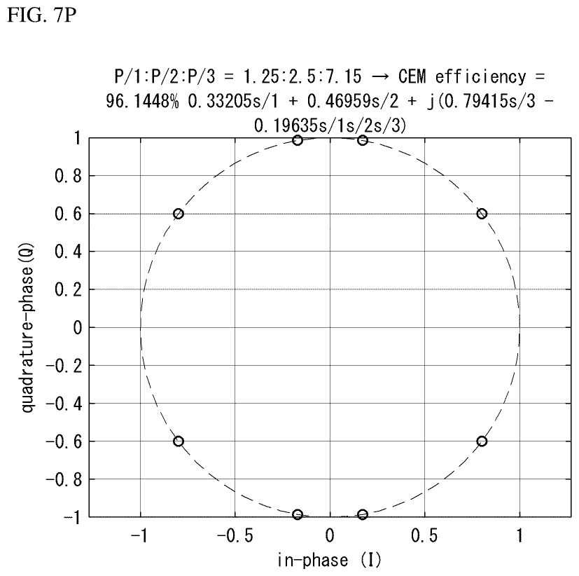

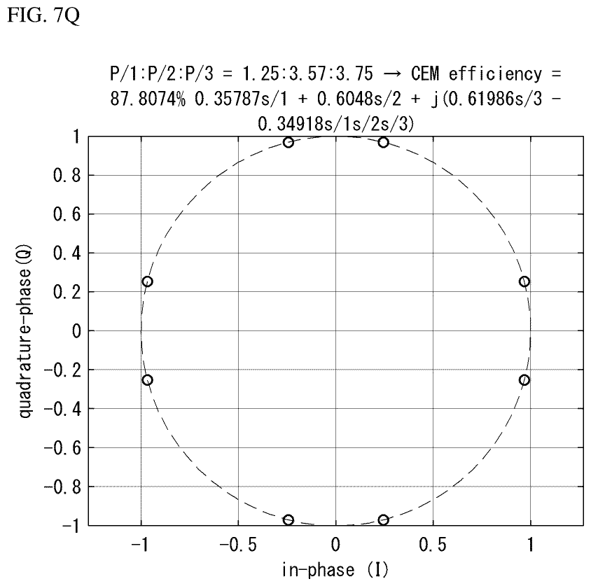

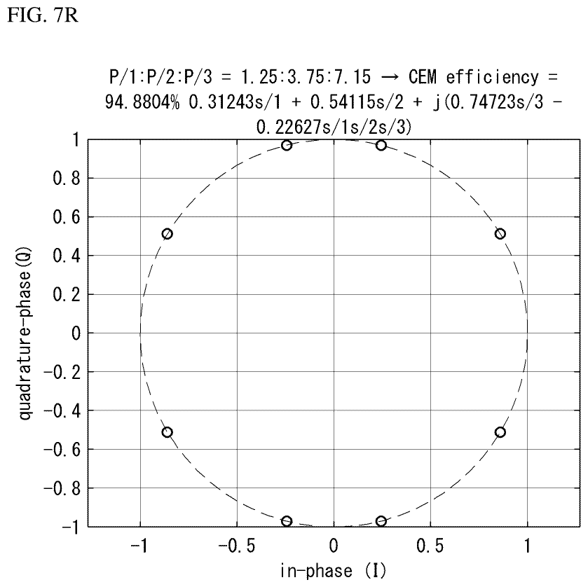

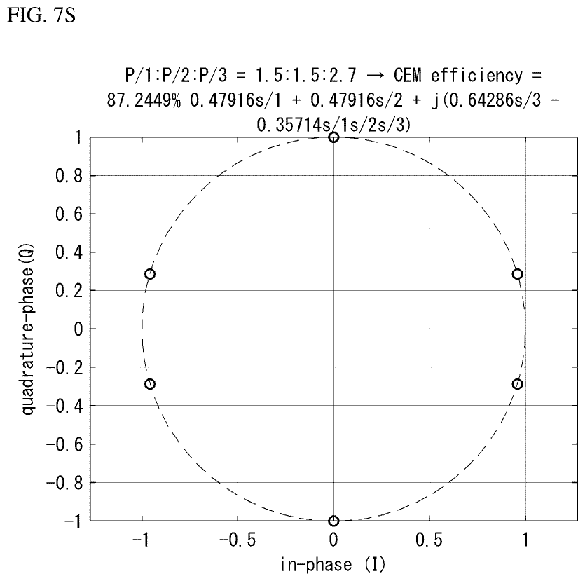

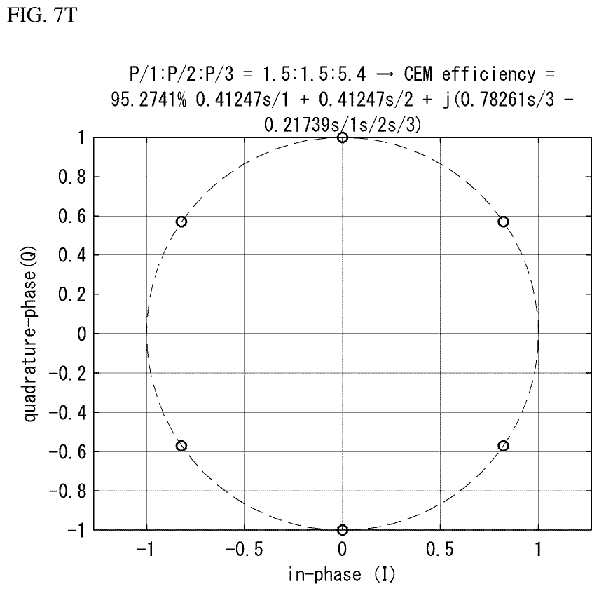

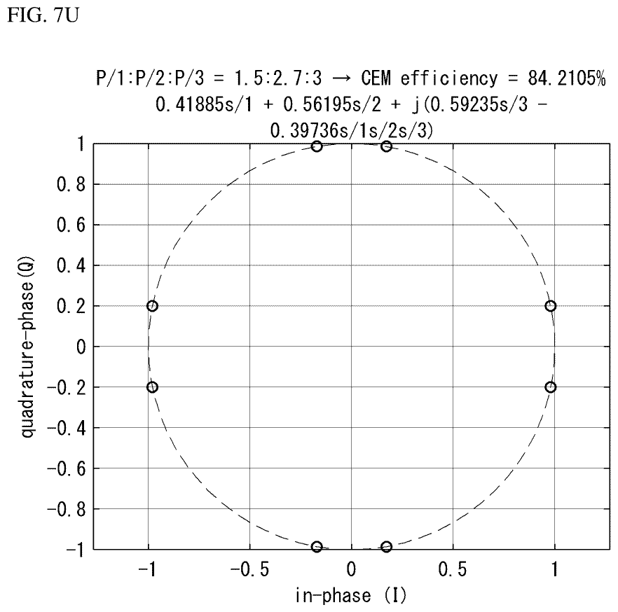

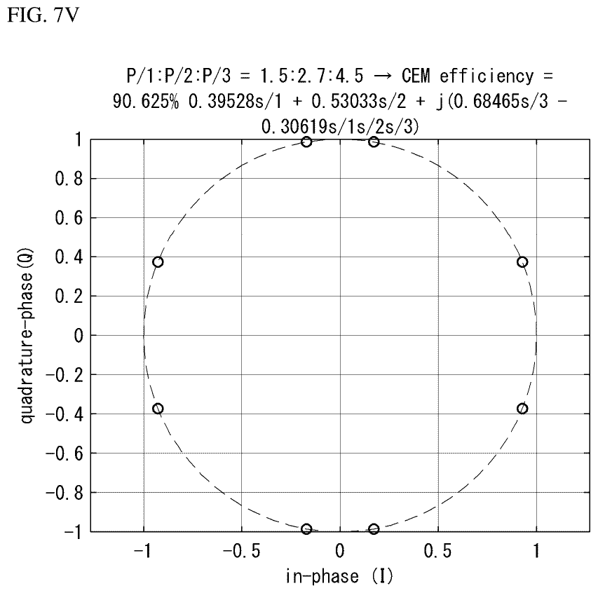

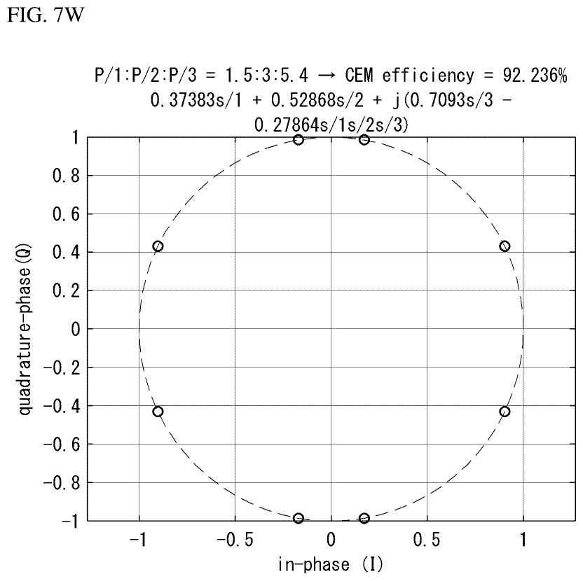

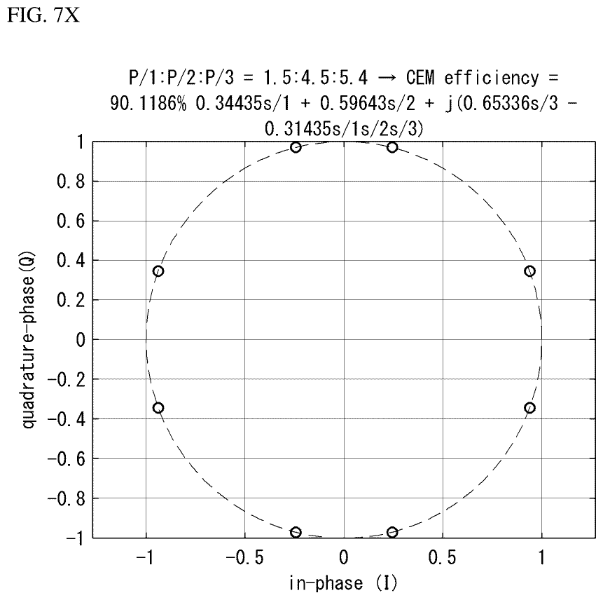

FIGS. 7A to 7X are exemplary diagrams illustrating embodiments of constellation diagrams for a constant envelope multiplexed signal in a communication system.

With reference to FIG. 7A to 7X, in an embodiment of a communication system, a constant envelope multiplexed signal S_{MUX} may be generated through a constant envelope multiplexing operation on a plurality of multiplexing target signals. Here, the constant envelope multiplexed signal S_{MUX} may be identical or similar to at least one of the constant envelope multiplexed signals described with reference to FIGS. 3 to 6.

The constant envelope multiplexed signal s_{MUX} obtained through the constant envelope multiplexing operation on the three multiplexing target signals s₁, s₂, and s₃ may be expressed as s_{MUX}=AS₁+Bs₂+j(Cs₃−Ds₁s₂s₃). Here, the real numbers A, B, and C may be determined based on the transmission powers P₁, P₂, and P₃ of the three multiplexing target signals s₁, s₂, and s₃, respectively. For example, it may be the case that A=\sqrt{P₁}, B=\sqrt{P₂}, and C=\sqrt{P₃}. Meanwhile, real number D may be determined based on real numbers A, B and C. For example, it may be the case that

$$D = \frac{AB}{C} .$$

The efficiency of the constant envelope multiplexing operation (i.e., CEM efficiency) may be determined based on the transmission power P₁, P₂, and P₃ values of the three multiplexing target signals s₁, s₂, and s₃. The CEM efficiency η may be calculated as in Equation 8 based on Equations 3 to 5.

$$η = 1 - \frac{{P}_{IM}}{{P}_{MUX}} = 1 - \frac{{P}_{1} {P}_{2}}{( {P}_{1} + {P}_{3} ) ( {P}_{2} + {P}_{3} )} \qquad Equation 8$$

Table 1 shows the constant envelope multiplexing design results according to the constant envelope multiplexing power configuration. That is, in Table 1, A, B, C, and D values and CEM efficiency values determined based on the transmission power P₁, P₂, and P₃ values of the three multiplexing target signals s₁, s₂, and s₃ are shown in 24 cases.

TABLE 1

| Constant envelope | | | | Constant envelope | | | | |
|---|---|---|---|---|---|---|---|---|
| multiplexing power configuration | | | | multiplexing design result | | | | |
| Number | P₁ | P₂ | P₃ | A | B | C | D | CEM Efficiency |
| Case #1 | 1.00 | 1.00 | 1.00 | 1.0000 | 1.0000 | 1.0000 | 1.0000 | 75.0000% |
| Case #2 | 1.00 | 1.00 | 2.00 | 1.0000 | 1.0000 | 1.4142 | 0.7071 | 88.8889% |
| Case #3 | 1.00 | 1.00 | 3.00 | 1.0000 | 1.0000 | 1.7321 | 0.5774 | 93.7500% |
| Case #4 | 1.00 | 1.00 | 5.38 | 1.0000 | 1.0000 | 2.3195 | 0.4311 | 97.5433% |
| Case #5 | 1.00 | 2.00 | 2.00 | 1.0000 | 1.4142 | 1.4142 | 1.0000 | 83.3333% |
| Case #6 | 1.00 | 2.00 | 3.00 | 1.0000 | 1.4142 | 1.7321 | 0.8165 | 90.0000% |
| Case #7 | 1.00 | 2.00 | 5.38 | 1.0000 | 1.4142 | 2.3195 | 0.6097 | 95.7523% |
| Case #8 | 1.00 | 3.00 | 3.00 | 1.0000 | 1.7321 | 1.7321 | 1.0000 | 87.5000% |
| Case #9 | 1.00 | 3.00 | 5.38 | 1.0000 | 1.7321 | 2.3195 | 0.7467 | 94.3888% |
| Case #10 | 1.25 | 1.25 | 2.25 | 1.1180 | 1.1180 | 1.5000 | 0.8333 | 87.2449% |
| Case #11 | 1.25 | 1.25 | 3.57 | 1.1180 | 1.1180 | 1.8894 | 0.6616 | 93.2745% |
| Case #12 | 1.25 | 1.25 | 7.15 | 1.1180 | 1.1180 | 2.6739 | 0.4675 | 97.7856% |
| Case #13 | 1.25 | 2.25 | 2.50 | 1.1180 | 1.5000 | 1.5811 | 1.0607 | 84.2105% |
| Case #14 | 1.25 | 2.25 | 3.75 | 1.1180 | 1.5000 | 1.9365 | 0.8660 | 90.6250% |
| Case #15 | 1.25 | 2.50 | 3.57 | 1.1180 | 1.5811 | 1.8894 | 0.9356 | 89.3189% |
| Case #16 | 1.25 | 2.50 | 7.15 | 1.1180 | 1.5811 | 2.6739 | 0.6611 | 96.1448% |
| Case #17 | 1.25 | 3.57 | 3.75 | 1.1180 | 1.8894 | 1.9365 | 1.0909 | 87.8074% |
| Case #18 | 1.25 | 3.75 | 7.15 | 1.1180 | 1.9365 | 2.6739 | 0.8097 | 94.8804% |
| Case #19 | 1.50 | 1.50 | 2.70 | 1.2247 | 1.2247 | 1.6432 | 0.9129 | 87.2449% |
| Case #20 | 1.50 | 1.50 | 5.40 | 1.2247 | 1.2247 | 2.3238 | 0.6466 | 95.2741% |
| Case #21 | 1.50 | 2.70 | 3.00 | 1.2247 | 1.6432 | 1.7321 | 1.1619 | 84.2105% |
| Case #22 | 1.50 | 2.70 | 4.50 | 1.2247 | 1.6432 | 2.1213 | 0.9487 | 90.6250% |
| Case #23 | 1.50 | 3.00 | 5.40 | 1.2247 | 1.7321 | 2.3238 | 0.9129 | 92.2360% |
| Case #24 | 1.50 | 4.50 | 5.40 | 1.2247 | 2.1213 | 2.3238 | 1.1180 | 90.1186% |

FIGS. 7A to 7X show the constellation diagrams corresponding to respective cases #1 to #24 listed in Table 1, the CEM efficiency values calculated in respective cases, and formulas obtained by dividing the calculation formular of the constant envelope multiplexed signal s_{MUX} by \sqrt{P_{MUX}} value in the respective cases. On the basis of the transmission power P₁, P₂, and P₃ values of the three multiplexing target signals s₁, s₂, and s₃, the constellation and CEM efficiency of the constant envelope multiplexed signal s_{MUX} may be determined differently.

The constant envelope multiplexing method and apparatus for a radio communication system according to an embodiment makes it possible for a communication node intending to transmit a plurality of transmission signals in a constant envelope multiplexed manner to multiply the transmission signals and intermodulation components of the transmission signals based on the transmission power of the respective transmission signals and generate a constant envelope multiplexed signal based on the linear combination and the quadrature phase combination for each multiplication result. Through this, it is possible to improve the efficiency of the constant envelope multiplexing operation.

However, the advantages achievable by the constant envelope multiplexing method and apparatus in a wireless communication system are not limited to the aforesaid, and other advantages not described herein may be clearly understood by those skilled in the art from the description made in the specification of the present application.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A multiplexed signal generation method of a first device in a communication system, the method comprising:
identifying a first to a third transmission power of a first to a third signal to be multiplexed to be transmitted;
generating an intermodulation component of the first to third signals;
multiplying the first to third signals and the intermodulation component based on the first to third transmission powers; and
generating a multiplexed signal having a constant envelope by performing quadrature phase combination on a linear combination result of the multiplied third signal and the multiplied intermodulation component and a linear combination result of the multiplied first and second signals,
wherein the third transmission power is equal to or greater than the first transmission power and the second transmission power.

2. The method of claim 1, wherein generating the intermodulation component comprises generating the intermodulation component through multiplication operation on the first to third signals.

3. The method of claim 1, wherein multiplying comprises multiplying the first to third signals based on a first to a third coefficient determined based on root values of the first to third transmission powers.

4. The method of claim 1, wherein multiplying comprises multiplying the intermodulation component based on a fourth coefficient determined based on a first to a third coefficient determined based on root values of the first to third transmission powers.

5. The method of claim 1, wherein generating the multiplexed signal comprises:
generating a first combined signal through a sum operation on the multiplied first signal and the multiplied second signal;
generating a second combined signal through a difference operation on the multiplied third signal and the multiplied intermodulation component; and
generating the multiplexed signal by quadrature-phase-combining the first and second combined signals.

6. The method of claim 5, wherein the first signal is represented by s₁, the second signal represented by s₂, the third signal represented by s₃, the first transmission power is represented by P₁, the second transmission power is represented by P₂, the third transmission power is represented by P₃, and the multiplexed signal is represented s_{MUX},
s_{MUX}=\sqrt{P₁}s₁+\sqrt{P₂}s₂+j(P₃\sqrt{s₃}−P₁P₂/P₃s₁s₂s₃).

7. The method of claim 1, wherein the first to third signals are bi-phase unit-power signals.

8. A first device of a communication system, the first device comprising:
a processor configured to control the first device to identify a first to a third transmission power of a first to a third signal to be multiplexed to be transmitted, generate an intermodulation component of the first to third signals, multiply the first to third signals and the intermodulation component based on the first to third transmission powers, and generate a multiplexed signal having a constant envelope by performing quadrature phase combination on a linear combination result of the multiplied third signal and the multiplied intermodulation component and a linear combination result of the multiplied first and second signals,
wherein the third transmission power is equal to or greater than the first transmission power and the second transmission power.

9. The first device of claim 8, wherein the processor is further configured to control the first device to generate the intermodulation component through multiplication operation on the first to third signals.

10. The first device of claim 8, wherein the processor is further configured to control the first device to multiply the first to third signals based on a first to a third coefficient determined based on root values of the first to third transmission powers.

11. The first device of claim 8, wherein the processor is further configured to control the first device to multiply the intermodulation component based on a fourth coefficient determined based on a first to a third coefficient determined based on root values of the first to third transmission powers.

12. The first device of claim 8, wherein the processor is further configured to control the first device to generate a first combined signal through a sum operation on the multiplied first signal and the multiplied second signal, generate a second combined signal through a difference operation on the multiplied third signal and the multiplied intermodulation component, and generate the multiplexed signal by quadrature-phase-combining the first and second combined signals.

13. The first device of claim 12, wherein the first signal is represented by s₁, the second signal represented by s₂, the third signal represented by s₃, the first transmission power is represented by P₁, the second transmission power is represented by P₂, the third transmission power is represented by P₃, and the multiplexed signal is represented s_{MUX},
s_{MUX}=\sqrt{P₁}s₁+\sqrt{P₂}s₂+j(P₃\sqrt{s₃}−P₁P₂/P₃s₁s₂s₃).
